(19) United States
(12) Patent Application Publication
(10) Pub. No.: US 2020/0336052 A1
(43) Pub. Date: Oct. 22, 2020

(54) ROTARY ACTUATOR

(71) Applicant: DENSO CORPORATION, Kariya-city (JP)

(72) Inventors: Kazunori SHIMADA, Kariya-city (JP); Mikine KUME, Kariya-city (JP); Hiroyuki KADO, Kariya-city (JP)

(21) Appl. No.: 16/848,024

(22) Filed: Apr. 14, 2020

(30) Foreign Application Priority Data
Apr. 16, 2019 (JP) 2019-077986

(51) Int. Cl. H02K 15/02; H02K 7/116; F16H 61/32; H02K 5/24; H02K 7/08; F16H 63/34; H02K 11/21; F16F 15/10

(52) U.S. Cl. CPC H02K 15/02; H02K 7/116; F16H 61/32; H02K 5/24; F16H 2061/326; F16H 63/3466; H02K 11/21; F16F 15/10; H02K 7/08

(57) ABSTRACT

A rotary actuator is used in a shift-by-wire system for a vehicle. The rotary actuator includes a stator, a rotor, a rotor support member, a controller, a controller fixing member, and a vibration absorber. The rotor is configured to be rotatable relative to the stator. The rotor support member rotatably supports a rotary shaft of the rotor. The controller controls energization to the stator. The controller is fixed to the controller fixing member. The vibration absorber prevents vibration transfer between the rotor support member and the controller fixing member.

### CROSS REFERENCE TO RELATED APPLICATIONS

This application is based on Japanese Patent Application No. 2019-077986 filed on Apr. 16, 2019, all of which is incorporated herein by reference.

### TECHNICAL FIELD

The present disclosure relates to a rotary actuator.

### BACKGROUND

Conventionally, there has been known an electromechanical integrated rotary actuator in which a motor housed in a case and a controller for controlling the motor are integrally formed. For example, in a typical rotary actuator, a case rotatably supports a rotor of a motor, and a controller is fixed inside a cover attached to the case.

### SUMMARY

One aspect of the present disclosure is a rotary actuator used in a shift-by-wire system for a vehicle. The rotary actuator includes a stator, a rotor, a rotor support member, a controller, a controller fixing member, and a vibration absorber. The rotor is configured to be rotatable relative to the stator. The rotor support member rotatably supports a rotary shaft of the rotor. The controller controls energization to the stator. The controller is fixed to the controller fixing member. The vibration absorber prevents vibration transfer between the rotor support member and the controller fixing member.

### BRIEF DESCRIPTION OF THE DRAWINGS

FIG. 1 is a schematic diagram showing a shift-by-wire system to which a rotary actuator according to a first embodiment is applied.

FIG. 2 is a diagram illustrating a shift range switching mechanism of FIG. 1.

FIG. 3 is a cross-sectional view of the rotary actuator according to the first embodiment.

FIG. 4 is an enlarged cross-sectional view of the rotary actuator of FIG. 3.

FIG. 5 is an enlarged cross-sectional view of a rotary actuator according to a second embodiment, which corresponds to FIG. 4 in the first embodiment.

### DETAILED DESCRIPTION

Hereinafter, a plurality of embodiments of a rotary actuator (hereinafter, referred to as an “actuator”) will be described with reference to the drawings. In the embodiments, substantially the same components are denoted by the same reference numerals and description thereof is omitted.

To begin with, a relevant technology will be described first only for understanding the embodiments below. In a rotary actuator, if it is installed in a vibrating environment, vibration of the rotor may be transferred to the controller through the case and the cover. Therefore, an incomplete connection between the terminal of the controller and the electrodes or an electric connection failure including a disconnection to the controller and a solder crack may occur.

The present disclosure has been provided in view of the above, and a rotary actuator in which occurrence of an electric connection failure can be suppressed will be presented through the following embodiments.

As described above, one aspect of the present disclosure is a rotary actuator used in a shift-by-wire system for a vehicle. The rotary actuator includes a stator, a rotor, a rotor support member, a controller, a controller fixing member, and a vibration absorber. The rotor is configured to be rotatable relative to the stator. The rotor support member rotatably supports a rotary shaft of the rotor. The controller controls energization to the stator. The controller is fixed to the controller fixing member. The vibration absorber prevents vibration transfer between the rotor support member and the controller fixing member.

By providing the vibration absorber between the portion that supports the rotor and the portion to which the controller is fixed, transfer of vibration from the rotor to the controller can be hindered. Therefore, it is possible to avoid an incomplete connection between the terminal of the controller and the electrodes or to avoid occurrence of an electrical connection failure including a disconnection to the controller and a solder crack.

### First Embodiment

In this embodiment, an actuator is used as a driver of a shift-by-wire system for a vehicle.

### (Shift-by-Wire System)

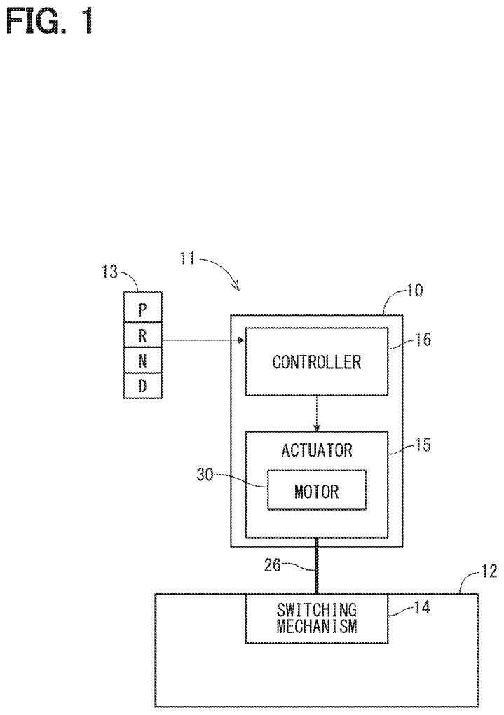

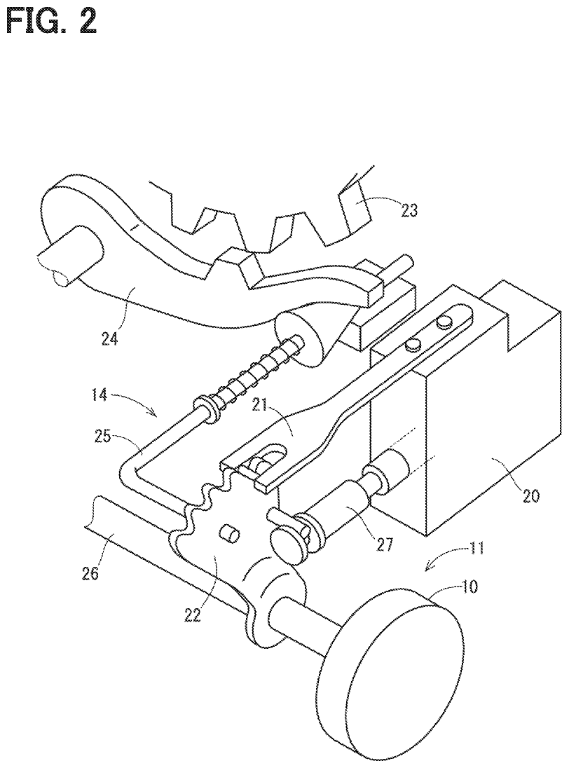

The configuration of the shift-by-wire system will be described with reference to FIGS. 1 and 2. As shown in FIG. 1, the shift-by-wire system 11 includes a shift operating device 13 that outputs an instruction (i.e., a command signal) to designate a shift range to the transmission 12 and an actuator 10 that operates a shift range switching mechanism 14 of the transmission 12. The actuator 10 includes an operating unit 15 that has a motor 30 and a controller 16 that controls energization to the motor 30 in response to a shift range instruction signal.

As shown in FIG. 2, the shift range switching mechanism 14 includes a range switching valve 20, a detent spring 21 and a detent lever 22, a park pole 24, and a manual shaft 26. The range switching valve 20 controls a supply of hydraulic pressure to a hydraulic operating mechanism in the transmission 12 (see FIG. 1). The detent spring 21 and the detent lever 22 are configured to keep a shift range. The park rod 25 is configured to prevent an output shaft from rotating by fitting the park pole 24 into a park gear 23 of the output shaft of the transmission 12 when the shift range is switched to a parking range. The manual shaft 26 rotates together with the detent lever 22.

The shift range switching mechanism 14 rotates the detent lever 22 together with the manual shaft 26 to move a valve body 27 and the park rod 25 of the range switching valve 20 connected to the detent lever 22 to a position corresponding to a target shift range. In the shift-by-wire system 11, the actuator 10 is connected to the manual shaft 26 in order to perform the shift range change electrically.

### (Actuator)

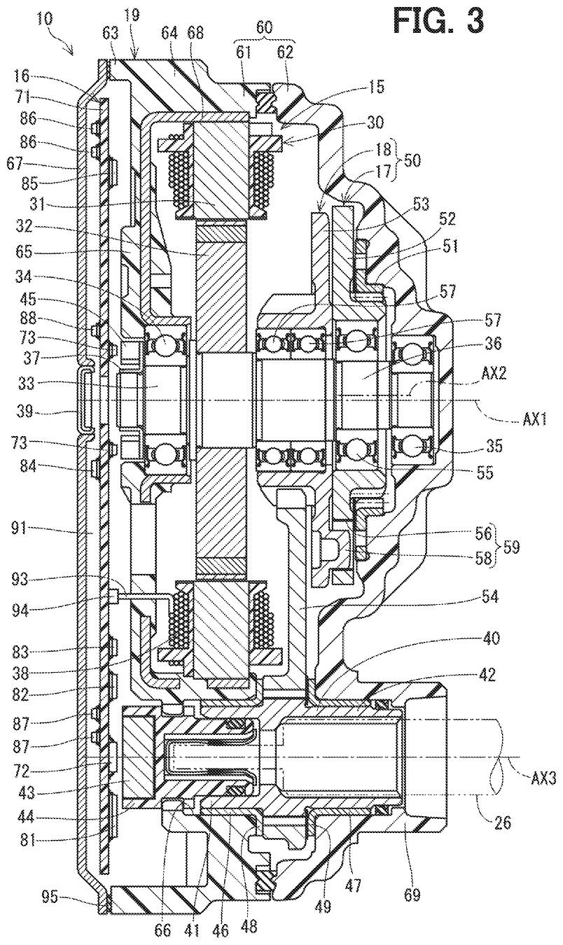

Next, the configuration of the actuator 10 will be described. As shown in FIG. 3, the actuator 10 is an electromechanical integrated actuator having the operating unit 15 and the controller 16 in a housing 91.

The housing 19 includes a cover 67 and a case 60 including a cylindrical upper case 61 and a cup-shaped lower case 62. A partition 65 is formed between one end 63 and the other end 64 of the upper case 61. The controller 16 is housed inside the one end 63. The controller 16 is covered by a cover 67 provided at an opening of the one end 63, thereby ensuring shielding for the control substrate 71. The lower case 62 is attached to the other end portion 64. Further, the lower case 62 includes a cylindrical protrusion 69 that protrudes away from the upper case 61. The manual shaft 26 is inserted into the cylindrical protrusion 69.

The operation unit 15 includes a motor 30 as a power source, an output shaft 40 disposed parallel to the motor 30, and a reducing mechanism 50 that reduces the rotational speed of the motor 30 and transmits the rotation to the output shaft 40. The operating unit 15 is housed in the case 60.

The motor 30 includes a stator 31 press-fitted into, and fixed to, a plate case 68 at the other end 64, a rotor 32 provided inside the stator 31, and a rotational shaft 33 that rotates about a rotation axis AX1 together with the rotor 32. Further, the rotational shaft 33 has an eccentric portion 36 eccentric with the rotation axis AX1 at a position on a side of the rotor 32 facing the lower case portion 62. The motor 30 is able to rotate bidirectionally by controlling a current supplied to the coil 38 constituting the stator 31 by the controller 16 and is also able to stop at a desired rotational position. A plug 39 is attached to a through hole of the cover 67. When a failure occurs, the rotational shaft 33 can be rotated manually after detaching the plug 39.

The speed-reducing mechanism 50 has a first speed-reducing portion 17 including a ring gear 51 and a sun gear 52 and a second speed-reducing portion 18 including a drive gear 53 and a driven gear 54 as parallel shafts type gears. The ring gear 51 is coaxially disposed with the rotation axis AX1. The sun gear 52 is rotatably supported about the eccentric axis AX by a bearing 55 fitted into the eccentric portion 36. The sun gear 52 meshes with, and is fits snugly inside, the ring gear 51. When the rotational shaft 33 rotates, the sun gear 52 performs planetary motion in which the sun gear 52 revolves around the rotation axis AX1 and rotates about the eccentric axis AX2. At this time, the rotation speed of the sun gear 52 is reduced with respect to the rotation speed of the rotary shaft 33. The sun gear 52 has a hole 56 for rotation transmission.

The drive gear 53 is provided on the rotation axis AX1 and is rotatably supported about the rotation axis AX1 by a bearing 57 fitted into the rotary shaft 33. Further, the drive gear 53 has a projection 58 for rotation transmission that is inserted into the hole 56. The rotation of the sun gear 52 is transmitted to the drive gear 53 through engagement between the hole 56 and the projection 58. The hole 56 and the projection 58 constitute a transmission mechanism 59. The driven gear 54 is provided on the rotation axis AX which is parallel to the rotation axis AX and coaxial with the cylindrical projection 69. The driven gear 54 meshes with the drive gear 53 to circumscribe the drive gear 53. When the drive gear 53 rotates about the rotation axis AX1, the driven gear 54 rotates about the rotation axis AX3. At this time, the rotation speed of the driven gear 54 is reduced relative to the rotation speed of the drive gear 53.

The output shaft 40 has a cylindrical shape, and is provided coaxially with the rotation axis AX3. The partition 65 has a through support hole 66 coaxial with the rotation axis AX3. The output shaft 40 is rotatably supported about the rotation axis AX3 by a first flanged bush 46 fitted into the through support hole 66 and a second flanged bush 47 fitted inside the cylindrical projection 69. The driven gear 54 is a separate member from the output shaft 40, is fitted outwardly to the output shaft 40, and is connected to the output shaft 40 to transmit rotation. The manual shaft 26 is inserted into the output shaft 40, and is coupled to the output shaft 40 through, for example, spline fitting so as to transmit rotation.

One end 41 of the output shaft 40 is rotatably supported by the first flanged bush 46. The other end 42 of the output shaft 40 is rotatably supported by the second flanged bush 47. The driven gear 54 is supported in the axial direction by being clamped between a first flange portion 48 of the first flanged bush 46 and a second flange portion 49 of the second flanged bush 47. In another embodiment, the driven gear 54 may be supported in the axial direction by being clamped between a pair of supporting portions such as the case 60 and another plate.

The controller 16 includes a plurality of electronic components for controlling the motor 30, a control board 71 on which the electronic components are mounted, an output shaft position detection sensor 72 mounted on the control board 71, and a motor position detection sensor 73 mounted on the control board 71.

The plurality of electronic components include a microcomputer 81, a MOSFET 82, a capacitor 83, a diode 84, an ASIC 85, an inductor 86, a resistor 87, a capacitor chip 88, and the like. The microcomputer 81 performs various types of a computation based on detection signals from the output shaft position detection sensor 72 and the motor position detection sensor 73, for example. The MOSFET 82 performs a switching operation based on a driving signal from the microcomputer 81 to switch energization to the coil 38. The capacitor 83 smoothens a power supplied from a power supply (not illustrated) and prevents noise propagation arising due to the switching operation by the MOSFET 82. The capacitor 83 constitutes a filter circuit together with the inductor 86. The ASIC 85 is an IC chip that performs a specific process at a high speed.

The output shaft position detection sensor 72 is disposed on the control substrate 71 at a position facing the magnet 43. The magnet 43 is fixed to a holder 44 attached to the output shaft 40. The output shaft position detection sensor 72 detects a rotational position of the output shaft 40 and the manual shaft 26 rotating together with the output shaft 40 by detecting a magnetic flux generated by the magnet 43.

The motor position detection sensor 73 is disposed on the control substrate 71 at a position facing the magnet 45. The magnet 45 is fixed to a holder 37 attached to the output shaft 33. The motor position detection sensor 73 detects rotational positions of the rotary shaft 33 and the rotor 32 by detecting a magnetic flux generated by the magnet 45.

### (Motor Supporting Structure and Controller Fixing Structure)

Next, a supporting structure for the motor 30 and a fixing structure for the controller 16 will be described. Hereinafter, the radial direction of the motor 30 is simply referred to as a “radial direction” and the circumferential direction of the motor 30 is simply referred to as a “circumferential direction”.

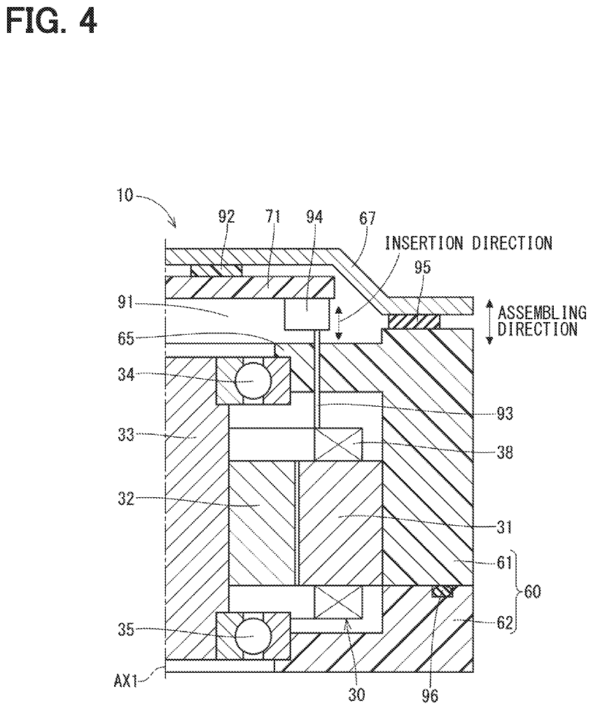

As shown in FIG. 4, the rotary shaft 33 of the motor 30 is rotatably supported by both a bearing 34 disposed in the upper case 61 and a bearing 35 disposed in the lower case portion 62. The upper case 61 supports the rotor 32 with a portion close to the controller 16. The upper case 61 serves as a rotor support member and is a part of the case 60 that houses the stator 31.

A controller space 91 for housing the controller 16 is defined between the cover 67 and the upper case 61. The control board 71 of the controller 16 is provided in the controller space 91 so that an extending direction of the control board 71 (hereinafter, referred to as a “board extending direction”) is orthogonal to the rotation axis AX1. The control board 71 is fixed to an inner wall of the cover 67 by a fixing member 92. The fixing member 92 is formed of, for example, a caulking means, a screw, an adhesive, a press-fit member, or the like. The cover 67 may serve as a controller fixing member.

The controller 16 has a connector 94 fixed to the control board 71 and connected to the terminal 93 of the coil 38. The terminal 93 extends from an inside of the case 60 and passes through the partition 65 in the axial direction. The frontage of the connector 94 faces the motor 30 in the axial direction. The direction along which the terminal 93 is inserted into the connector 94 is the axial direction. On the other hand, the direction along which the cover 67 is connected to the upper case 61 is also the axial direction. That is, the direction along which the terminal 93 is inserted into the connector 94 is the same as the direction along which the cover 67 is assembled to the upper case 61.

In FIG. 4, the terminal 93 is illustrated as extending directly from the coil 38. However, the present disclosure is not necessarily limited this configuration. For example, a bus bar may be provided between the coil 38 and the control board 71, and then the terminal may extend from the bus bar.

A seal member 95 is disposed at a connecting portion between the cover 67 and the upper case 61. The seal member 95 is, for example, an elastic body such as rubber or the like, and is an annular member extending along a connecting surface of the cover 67 to provide airtightness in the controller space 91. The cover 67 and the upper case 61 are not in direct contact with each other, but are integrally provided via the seal member 95. The seal member 95 functions as a vibration absorber that prevents vibration transfer between the cover 67 and the upper case 61.

A seal member 96 is disposed at a connecting portion between the upper case 61 and the lower case 62. The seal member 96 is an elastic member and provides airtightness in the controller space 91.

As described above, in the first embodiment, the actuator 10 includes the stator 31, the rotor 32 rotatable relative to the stator 31, the upper case 61 as a rotor support member that rotatably supports the rotary shaft 33 of the rotor 32, the controller 16 that controls energization to the stator 31, the cover 67 as a controller fixing member to which the controller 16 is fixed, and the seal member 95 as a vibration absorber that suppresses vibration transfer between the upper case 61 and the cover 67.

By providing the vibration absorber between the portion that supports the rotor 32 and the portion to which the controller 16 is fixed, transfer of vibration from the rotor 32 to the controller 16 can be suppressed. Therefore, it is possible to avoid an incomplete connection between the terminal of the controller 16 and the electrodes or to avoid occurrence of an electrical connection failure including a disconnection to the controller 16 and a solder crack.

Further, in the first embodiment, the rotor support member is the upper case 61 that houses the stator 31. The controller fixing member is the cover 67 that defines, together with the upper case 61, the controller space 91 that houses the controller 16. Accordingly, the controller 16 can be positioned away from the motor 30. Therefore, it is not necessary to form a through hole in the control board 71 through which the rotary shaft 33 is inserted.

In the first embodiment, the controller 16 has the connector 94 connected to the terminal 93 of the coil 38 of the stator 31. The direction along which the terminal 93 is inserted into the connector 94 is the same as the direction along which the cover 67 is assembled to the upper case 61. Hence, the electrical connection between the controller 16 and the coil 38 can be completed at the same time as the cover 67 is assembled to the upper case 61. Therefore, even when the controller 16 is disposed close to the cover 67, the controller 16 can be easily connected to the motor 30.

In the first embodiment, the seal member 96 is an elastic member and provides airtightness in the controller space 91. By using the seal member 95 as the vibration absorber, it is not necessary to provide a separate vibration absorber, and as a result the number of components can be reduced.

### Second Embodiment

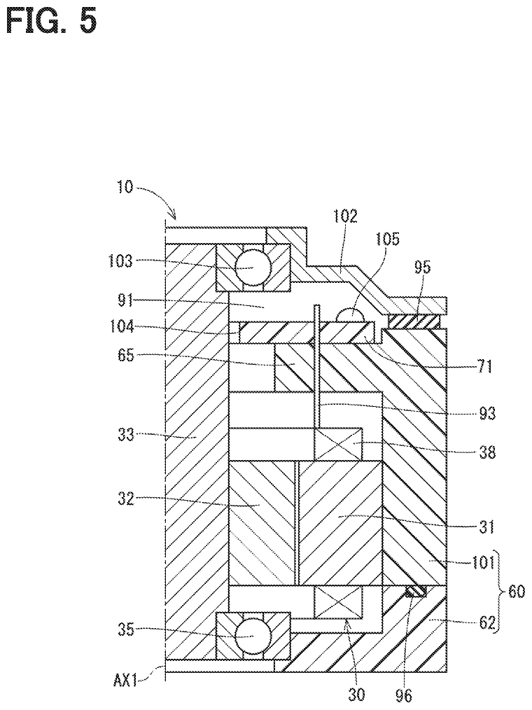

In the second embodiment, as shown in FIG. 5, the control board 71 is fixed to the partition 65 of the upper case 101 in the controller space 91 by the fixing member 105. A fixing member 105 is formed of, for example, a caulking means, a screw, an adhesive, a press-fit member, or the like. The upper case 101 may serve as a controller fixing member.

The rotary shaft 33 is rotatably supported by both a bearing 34 disposed in the cover 10 and a bearing 35 disposed in the lower case 62. The cover 102 may serve as a rotor support member. A seal member 95 is provided between the upper case 101 and the cover 102 as a vibration absorber to prevent vibration transfer. The control board 71 is provided on the rotary shaft 33 and has a through hole 104 through which the rotary shaft 33 passes.

As described above, in the second embodiment, transfer of the vibration from the rotor 32 to the controller 16 is suppressed by the vibration absorber disposed between the rotor support member and the controller fixing member. Therefore, it is possible to avoid an incomplete connection between the terminal of the controller 16 and the electrodes or to avoid occurrence of an electrical connection failure including a disconnection to the controller 16 and a solder crack.

Further, in the second embodiment, the controller fixing member is the upper case 101 that houses the stator 31. The rotor support member is the cover 102 that defines, together with the upper case 101, the controller space 91 that houses the controller 16. By fixing the controller 16 to the upper case 101, heat generated at the controller 16 can be effectively released to the case 60 which is a motor housing.

In the second embodiment, the control board 71 has a through hole 104 through which the rotary shaft 33 passes. Thus, it is possible to secure a mounting area of the control board 71 while supporting the rotary shaft 33 with the cover 102.

### Other Embodiments

In another embodiment, the vibration absorber may be a member different from the seal member. Further, the vibration absorber may be formed of a spring made of metal, resin, or the like, or may be formed of a damper. Further, the vibration absorber is not necessarily limited to one annular member, and may be formed to be scattered along the circumferential direction, and a plurality of vibration absorbers may be provided.

The present disclosure is not limited to the embodiments described above, and can be implemented in various forms without departing from the spirit of the invention.

1. A rotary actuator used in a shift-by-wire system for a vehicle, the rotary actuator comprising:
a stator;
a rotor that is configured to be rotatable relative to the stator;
a rotor support member that rotatably supports a rotary shaft of the rotor;
a controller that controls energization to the stator;
a controller fixing member to which the controller is fixed; and
a vibration absorber that prevents vibration transfer between the rotor support member and the controller fixing member.

2. The rotary actuator according to claim 1, wherein
the rotor support member is a portion of a case that houses the stator, and
the controller fixing member is a cover that defines, together with the rotor support member, a space to house the controller therein.

3. The rotary actuator according to claim 2, wherein
the controller includes a connector connected to a terminal of the stator, and
the terminal is inserted into the connector in a same direction as a direction in which the controller fixing member is connected to the rotor support member.

4. The rotary actuator according to claim 1, wherein
the controller fixing member is a portion of a case that houses the stator, and
the rotor support member is a cover that defines, together with the controller fixing member, a space to house the controller therein.

5. The rotary actuator according to claim 4, wherein
the controller defines a through hole into which the rotary shaft is inserted.

6. The rotary actuator according to claim 1, wherein
the vibration absorber is an elastic member that seals a space between the rotor support member and the controller fixing member to secure airtightness in the space.
